(19) United States
(12) Patent Application Publication
(10) Pub. No.: US 2025/0091531 A1
(43) Pub. Date: Mar. 20, 2025

(54) STRUCTURAL ELEMENT SYSTEM WITH INSULATING ELEMENT ARRANGED THEREIN

(71) Applicant: SIKA TECHNOLOGY AG, Baar (CH)

(72) Inventor: Henrik LINDGREN, Feluy (BE)

(73) Assignee: SIKA TECHNOLOGY AG, Baar (CH)

(21) Appl. No.: 18/727,403

(22) PCT Filed: Feb. 1, 2023
(86) PCT No.: PCT/EP2023/052388

§ 371 Date: Jul. 9, 2024

(30) Foreign Application Priority Data
Feb. 11, 2022 (EP) 22156393.5

(51) Int. Cl. B60R 13/08; B62D 25/00; B62D 29/00

(52) U.S. Cl. CPC B60R 13/08; B62D 25/00; B62D 29/00; B60R 13/0815

(57) ABSTRACT

A structural element system for a motor vehicle with a damping element arranged in the structural element, including: a structural element which includes two joined walls which form, in one portion, a cavity having at least two open ends, a first wall in this portion having an opening; a damping element with a support and an expandable material arranged on the support, the support including a closed surface and at least one side wall fastened to this closed surface by ribs; wherein the damping element is arranged in the structural element such that the closed surface of the support covers the opening of the first wall and in that the side wall substantially partially closes an open end of the cavity.

The invention relates to a system of a structural element of a motor vehicle, having an insulating element arranged in the structural element.

In many cases, components such as, for example, vehicle bodies and/or frames of means of transport and locomotion, in particular of water or land vehicles or of aircraft, have structures with cavities in order to allow lightweight designs. However, these cavities cause a wide variety of problems. Depending on the type of the cavity, the latter has to be sealed in order to prevent the ingress of moisture and dirt, which may lead to corrosion of the components. It is often also desirable to substantially reinforce the cavities and therefore the component, but to maintain the low weight. It is often also necessary to stabilize the cavities and therefore the components, in order to reduce noise which would otherwise be transmitted along or through the cavity. Many of these cavities have an irregular shape or a narrow extent, which makes it more difficult to seal, reinforce and insulate them properly.

Especially in automotive construction, but also in aircraft construction and boatbuilding, sealing elements (baffles) are therefore used in order to seal and/or acoustically insulate cavities, or reinforcing elements (reinforcers) are used in order to reinforce cavities.

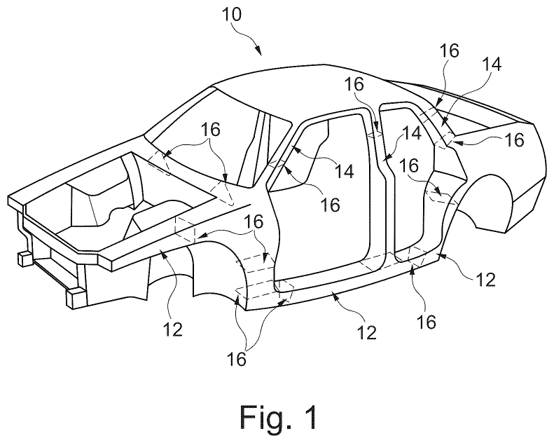

FIG. 1 schematically illustrates a vehicle body of an automobile. The vehicle body 10 here has various structures with cavities, for example pillars 14 and carriers or struts 12. Such structural elements 12, 14 with cavities are usually sealed or reinforced with sealing and/or reinforcing elements 16.

Such conventional sealing elements 16 typically close a cross section of the respective structural elements 12, 14. In order to achieve better acoustic insulation, it has recently become increasingly common for entire portions of such structural elements 12, 14 to be filled with foam or sealed. This trend is growing due to the increased use of electric vehicles, because the background noise in such electric vehicles is different than that in conventional vehicles with an internal combustion engine, and because higher demands are thus placed on the noise insulation of the interior compartment.

In order to satisfy these increased demands with regard to noise insulation in vehicles, use is increasingly being made of two-component polyurethane foams, with which such portions in structural elements are filled. Said solution is, however, disadvantageous because it requires production lines to be equipped with expensive robots, and because it is also more labour- and material-intensive. For example, sealing elements have to be used in order to limit the expansion of these two-component foams. Said solution is furthermore disadvantageous because such two-component polyurethane foams typically contain isocyanates, which are poisonous (in particular carcinogenic) and the use of which therefore requires enhanced occupational safety measures and increased use of material and equipment.

It is therefore an object of the present invention to provide sealing solutions which firstly satisfy increased demands with regard to acoustic insulation and which are secondly less labour- and/or cost-intensive. In particular, such a new sealing solution should be suitable for electrically powered motor vehicles.

Said object is firstly achieved by means of a system of a structural element of a motor vehicle, having an insulating element arranged in the structural element, the system comprising: a structural element which comprises at least two joined walls which, in one portion, form a cavity having at least two open ends, wherein a first wall has at least one opening in said portion; an insulating element comprising a carrier and an expandable material arranged on the carrier, wherein the carrier comprises a closed surface and at least one side wall that is fastened to said closed surface via ribs, and wherein the expandable material has an expansion rate of at least 800%; wherein the insulating element is arranged in the structural element such that the closed surface of the carrier overlaps and covers the opening of the first wall as seen in a plan view of the opening, and such that the at least one side wall is arranged substantially in a plane of a cross section in a region of an open end of the cavity and thus closes the cross section of the cavity in the region of the open end over at least 50% of said cross section.

Said solution has the advantage that numerous functions can thus be performed by a single component. Firstly, by means of said component, it is possible for a large volume of a portion of the structural element to be filled with foam, whereby very high acoustic insulation performance can be achieved. Secondly, with such a component, it can be ensured that the inside of said portion is filled with foam in a targeted manner. In particular, by virtue of the closed surface being provided as part of the carrier, certain regions of the cavity can be shielded and kept free from expanded material. This is not possible, or is possible only with great difficulty, when using two-component foams. In that case, it is specifically necessary for additional elements to be used for shielding individual regions, such as openings in walls of the structural element, and to be removed again after a foaming operation. This then necessitates increased use of material and increased work effort.

A further advantage of the solution proposed here is that it makes it possible to achieve similar and/or better acoustic insulation than when using two-component polyurethane foams, but the use of baffles means that the insulation system is nevertheless much easier to handle and apply. These proposed insulating elements may be fitted in the structural elements even before the vehicle body is dip painted, with said insulating elements being expanded in the baking oven after the painting process. In the case of two-component polyurethane foams, both an application process and the equipment requirements are much more complex and expensive.

Two-component foams furthermore have the disadvantage that the spaces that are to be filled with foam have to be delimited using suitable blockers. This in turn necessitates increased assembly and work effort.

The solution proposed here offers the advantage in particular that particularly good acoustic insulation performance can be achieved for airborne sound waves in a frequency range between 500 and 3000 Hz. Since this frequency range is commonly encountered in particular in electrically powered motor vehicles, the solution proposed here is particularly suitable for use in vehicles with alternative drive systems.

In the context of this invention, the term “insulating element” or “insulation” or “insulated” covers elements or structures or method steps for partitioning and/or closing off and/or insulating a structural element. These various characteristics of such an insulating element may occur individually or in combination with one another.

In one exemplary embodiment, the system is in a motor vehicle having an electric drive, in particular in a motor vehicle without an internal combustion engine.

In one exemplary embodiment, as seen in a plan view of the opening, the closed surface covers an area amounting to at least 300% of an area of the opening. In one preferred embodiment, the area of the closed surface amounts to at least 400% or at least 600% or at least 800% of the area of the opening.

Such an embodiment of the closed surface of the carrier has the advantage that a region of an opening in the wall of the structural element can thus be kept free from expanded material, such that said opening remains functional for the intended assembly purpose. Here, aside from arranging the insulating element correctly, no further measures need to be taken.

In one exemplary embodiment, the closed surface is arched in the shape of a dome over the opening.

In one exemplary embodiment, an edge region of the closed surface is spaced from the first wall by less than 5 mm.

The formation of such an arch in the closed surface has the advantage that a blockage of the opening in the wall of the structural element with foam can thus be reliably prevented by virtue of a shield-like cover being provided for the opening.

Furthermore, such an arched form of the closed surface has the advantage that a space required for an intended assembly purpose is thus kept free. For example, clips that are often inserted into such openings have a certain structural height that requires such a free space.

In one exemplary embodiment, the at least one side wall closes the cross section in a region of an open end of the cavity in each case over at least 60% or at least 70% or at least 80% of said cross section.

Such a degree of closure of the cross sections of the open ends of the cavity has the advantage that, firstly, it is thus possible for an expansion of the expandable material to be reliably stopped at an intended location, whilst secondly an open cross section sufficient to ensure a circulation of coating liquids is provided.

In one exemplary embodiment, the carrier has two side walls which are spaced from one another by at least 100 mm. In one exemplary embodiment, the two side walls are spaced from one another by at least 120 mm or 150 mm.

Such an embodiment of the carrier has the advantage that a larger portion of the structural element can thus be filled with foam, or insulated, than is possible when using conventional insulating elements.

In one exemplary embodiment, the carrier has two side walls which are arranged at an angle of between 30° and 150° with respect to one another. In one exemplary embodiment, the two side walls are arranged at an angle of between 60° and 120° with respect to one another.

Such an arrangement of the side walls has the advantage that portions of structural elements which are not of elongate shape, but which are of arcuate shape or are T-shaped, can thus also be effectively insulated.

In one exemplary embodiment, the carrier has at least two side walls, wherein the closed surface of the carrier is arranged substantially between the side walls.

In one exemplary embodiment, a spacing between in each case one side wall and the closed surface is at least 20 mm, such that a layer of the expanded material with a thickness of at least 20 mm can be formed on the particular side wall as a result of an expansion of the expandable material.

In one exemplary embodiment, said spacing is at least 30 mm or at least 40 mm or at least 50 mm.

Such spacings between the side wall and the closed surface of the carrier have the advantage that a correspondingly thick layer of expanded material can thus be formed on the side walls, such that high acoustic insulation performance can be achieved. In tests, it has been found that, in particular, the combination of a side wall of the carrier with a thick layer of expanded material achieves a particularly good acoustic insulation action.

In one exemplary embodiment, the expandable material has an expansion rate of at least 2000%, preferably of at least 2500%, particularly preferably of at least 3000%.

The provision of an expandable material with particularly high expansion rates has the advantage that insulating elements of lighter weight can thus be used. This aspect is of particular importance because, in the case of the solution proposed here, it is the intention for a large volume to be filled with expandable foam material.

In one exemplary embodiment, in a region of the opening, no expandable material is arranged on that side of the closed surface which faces toward the opening.

Such an arrangement has the advantage that the opening in the wall of the structural element can thus be kept free from expanded material.

In one exemplary embodiment, more expandable material is arranged on a side of the carrier facing away from the opening than on a side of the carrier facing toward the opening.

This has the advantage that the portion can be filled with foam in a targeted manner, with certain regions of the cavity being shielded against being filled with foam.

In one exemplary embodiment, the expandable material is arranged and dimensioned such that a region between the closed surface and the second wall is completely filled with expanded material after an expansion process.

This has the advantage that acoustic insulation performance can thus be yet further increased.

In one exemplary embodiment, each side wall is connected to the closed surface by means of two to six ribs.

The provision of a small number of ribs between the side walls and the closed surface has the advantage that these regions are thus filled as completely as possible with foam, and that a weight of the carrier can furthermore be kept as low as possible.

In one exemplary embodiment, the portion of the structural element is of elongate shape and forms a cavity having two open ends.

In one exemplary embodiment, the carrier has two side walls that partially close in each case one open end of the cavity.

In an alternative embodiment, the portion of the structural element is T-shaped and forms a cavity having three open ends.

In one exemplary embodiment, the carrier has three side walls that partially close in each case one open end of the cavity.

In one exemplary embodiment, the carrier furthermore has a fastening element for temporarily fixing the insulating element to the structural element.

In one exemplary embodiment, the insulating element has two such fastening elements.

In one exemplary embodiment, the fastening element or fastening elements is or are of clip or push pin form.

In an alternative embodiment, the fastening element or fastening elements is or are of welding lug or hook or adhesive strip or magnetic element form.

The expandable material used may in principle be various materials that can be made to foam. Typically, the expandable material is made to expand thermally, by moisture or by electromagnetic radiation.

Such an expandable material typically has a chemical or a physical blowing agent. Chemical blowing agents are organic or inorganic compounds which decompose under the effect of temperature, moisture or electromagnetic radiation, at least one of the breakdown products being a gas. Physical blowing agents used may, for example, be compounds that are converted to the gaseous state with an increase in temperature. Both chemical and physical blowing agents are therefore capable of creating foam structures in polymers.

The expandable material is preferably foamed thermally, chemical blowing agents being used. Examples of suitable chemical blowing agents are azodicarbonamides, sulfohydrazides, hydrogencarbonates or carbonates.

Suitable blowing agents are, for example, also commercially available under the trade name Expancel® from Akzo Nobel, the Netherlands, or under the trade name Celogen® from Chemtura Corp., USA.

The heat required for the foaming may be introduced by external or by internal heat sources, such as an exothermic chemical reaction. The foamable material is preferably foamable at a temperature ≤250° C., in particular from 100° C. to 250° C., preferably from 120° C. to 240° C., preferably from 130° C. to 230° C.

Suitable expandable materials are, for example, one-component epoxy resin systems which do not flow at room temperature and in particular have elevated impact strength and contain thixotropic agents such as aerosils or nanoclays. For example, epoxy resin systems of this type contain 20 to 50 wt % of a liquid epoxy resin, 0 to 30 wt % of a solid epoxy resin, 5 to 30 wt % of impact modifiers, 1 to 5 wt % of physical or chemical blowing agents, 10 to 40 wt % of fillers, 1 to 10 wt % of thixotropic agents and 2 to 10 wt % of thermally activatable curing agents. Suitable impact modifiers are reactive liquid rubbers based on nitrile rubber or derivatives of polyether polyol polyurethanes, core-shell polymers and similar systems known to a person skilled in the art.

Likewise suitable expandable materials are one-component polyurethane compositions containing blowing agents and based on crystalline polyesters which have OH groups and have been mixed with further polyols, preferably polyether polyols, and polyisocyanates with blocked isocyanate groups. The melting point of the crystalline polyester should be ≥50° C. The isocyanate groups of the polyisocyanate may be blocked, for example, by nucleophiles such as caprolactam, phenols or benzoxalones.

Also suitable are blocked polyisocyanates as used, for example, in powder-coating technology, which are commercially available, for example, under the trade names Vestagon® BF 1350 and Vestagon® BF 1540 from Degussa GmbH, Germany. So-called encapsulated or surface-deactivated polyisocyanates, which are known to a person skilled in the art and are described for example in EP 0 204 970, are likewise suitable isocyanates.

Also suitable as expandable materials are two-component epoxy/polyurethane compositions which contain blowing agents, as described, for example, in WO 2005/080524 A1.

Also suitable as expandable materials are ethylene-vinyl acetate compositions containing blowing agents.

Expandable materials that are also suitable are sold by Sika Corp., USA, for example under the trade name SikaBaffle® 240, SikaBaffle® 250 or SikaBaffle® 255, and are described in U.S. Pat. Nos. 5,266,133 and 5,373,027. Such expandable materials are particularly preferred for the present invention.

In one exemplary embodiment, the expandable material is in the form of a thermally induced material.

This has the advantage that the oven for baking the dip coating liquid may thereby be used to expand the expandable material and therefore to insulate the cavity. Consequently, no additional working step is required.

The carrier may consist of any desired materials. Preferred materials are plastics, in particular polyurethanes, polyamides, polyesters and polyolefins, preferably high temperature-resistant polymers such as poly (phenylene ether), polysulfones or polyether sulfones; or any desired combinations of these materials. Polyamides, in particular polyamide 6, polyamide 6,6, polyamide 11, polyamide 12, or a mixture thereof, are particularly preferably used.

In one exemplary embodiment, the carrier and the expandable material are produced in a two-component injection-molding process.

In an alternative embodiment, the carrier and the expandable material are not produced in a common process. For example, the carrier may be produced in an injection-molding process or in a three-dimensional printing process, and the expandable material may be extruded onto the carrier in a subsequent production step.

In a further alternative embodiment, the insulating element comprises a carrier and an expansion element arranged thereon. Here, the expansion element comprises the expandable material. Furthermore, the expansion element may comprise its own carrier and a coupling element for connection to the carrier of the insulating element.

The provision of such expansion elements has the advantage that standardized expansion elements can thus be used, which, depending on requirements, can be used with different carriers to form different insulating elements. For example, in one case, a carrier having a first shape may be combined with two expansion elements to form one insulating element, and in a second case, a carrier having a second shape may be combined with four expansion elements to form a different insulating element.

Details and advantages of the invention will be described below with the aid of exemplary embodiments and with reference to schematic drawings. In the drawings:

FIG. 1 shows an exemplary illustration of a vehicle body;

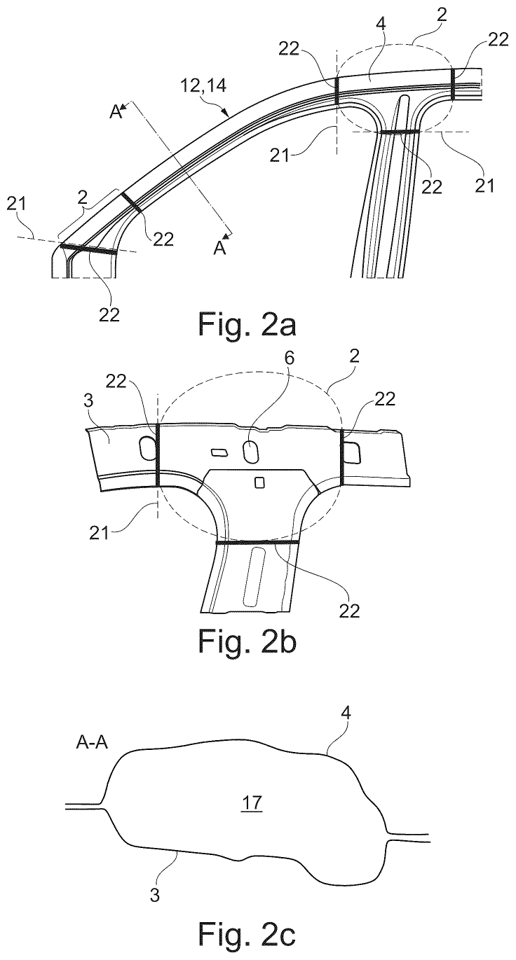

FIGS. 2a to 2c show an exemplary illustration of a portion of a structural element and of a cavity of the structural element;

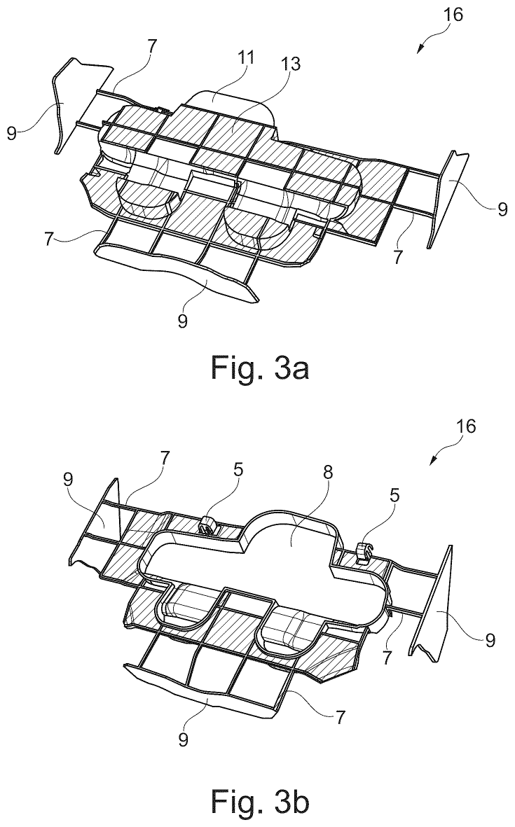

FIGS. 3a and 3b show an exemplary illustration of an insulating element;

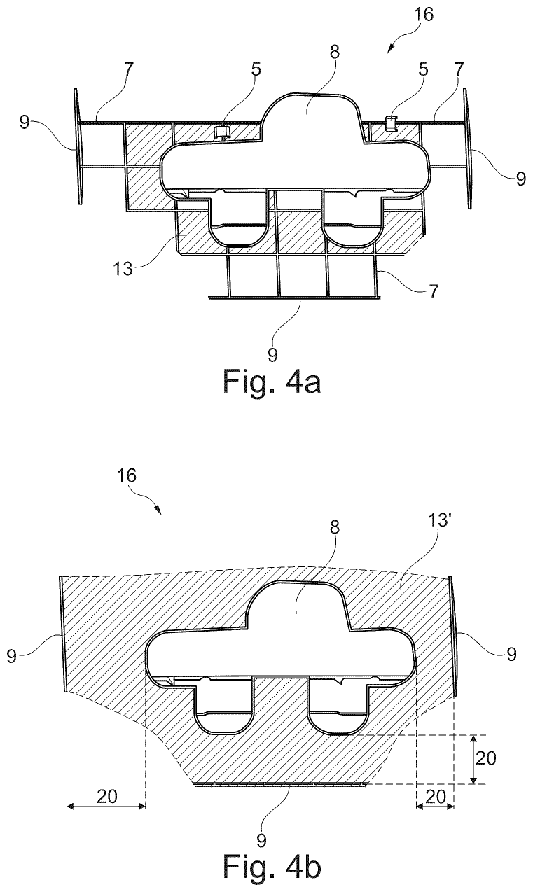

FIGS. 4a and 4b show an exemplary illustration of an insulating element;

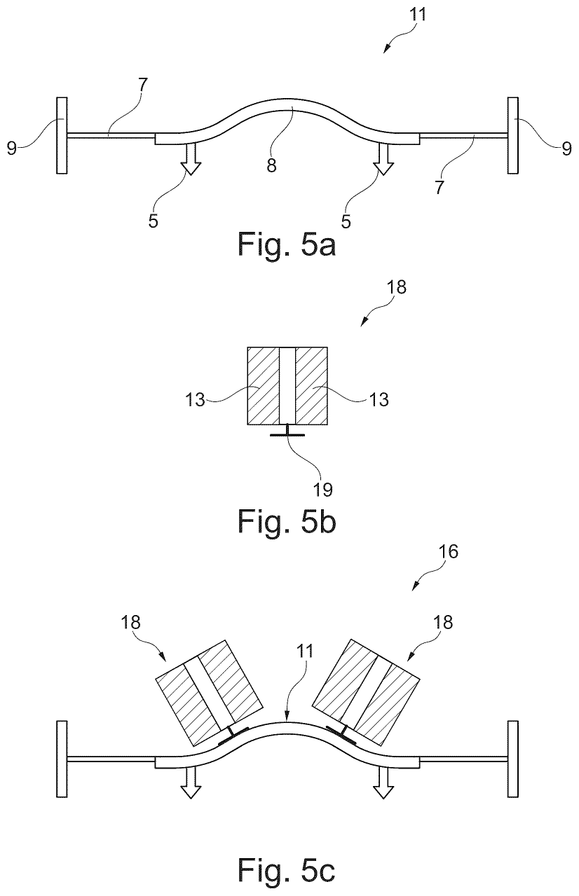

FIGS. 5a to 5c show an exemplary illustration of an insulating element;

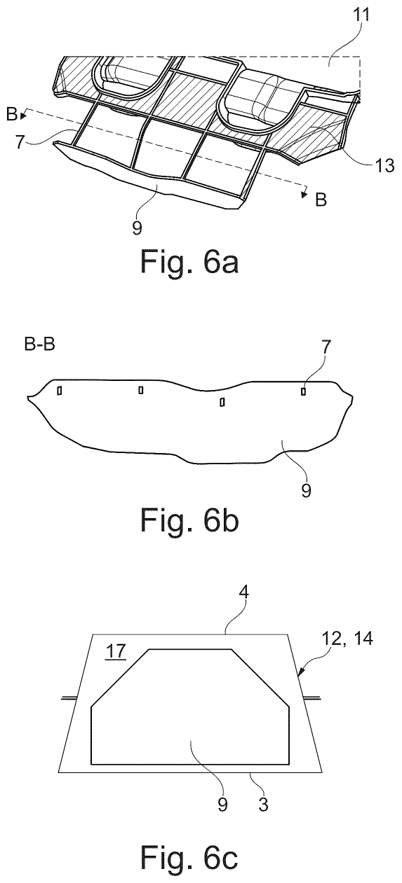

FIGS. 6a to 6c show an exemplary illustration of a side wall;

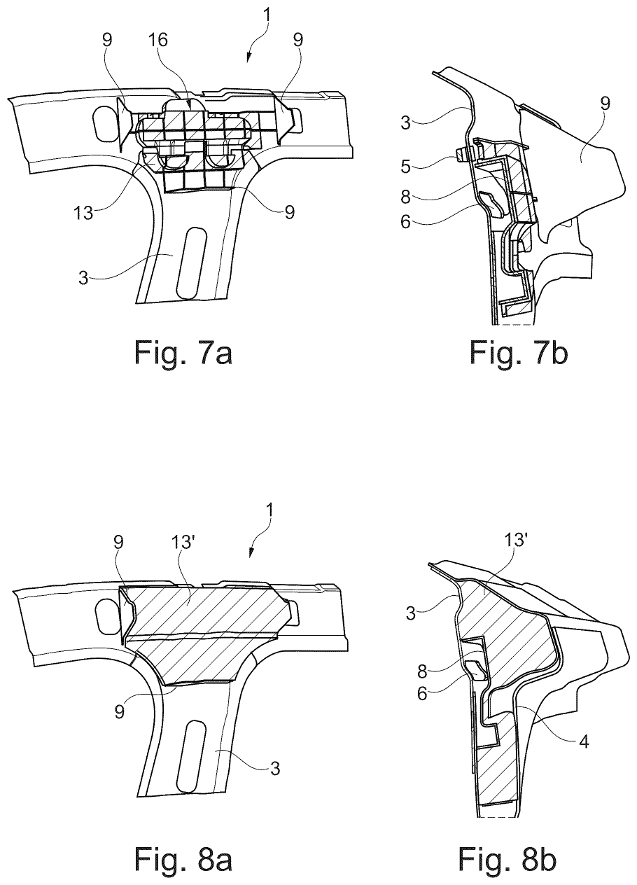

FIGS. 7a and 7b show an exemplary illustration of an insulating element in a structural element in a non-expanded state; and

FIGS. 8a and 8b show an exemplary illustration of an insulating element in a structural element in an expanded state.

A detail of a structural element 12, 14 is illustrated in each of FIGS. 2a to 2c. FIG. 2a shows two portions 2 in the structural element 12, 14 that are typically insulated using insulating elements. Here, one of these portions 2 is of elongate shape and has two open ends 22, and the other of these portions 2 is T-shaped and has three open ends 22.

In this external view of the structural element 12, 14, only the second wall 4 is visible, which in this exemplary embodiment corresponds to an outer wall of the structural element 12, 14.

FIG. 2b illustrates the T-shaped portion 2 from FIG. 2a in more detail. By contrast to FIG. 2a, only the first wall 3 of the structural element 12, 14 is shown in FIG. 2b. Said first wall 3 has an opening 6.

Finally, FIG. 2c is a cross-sectional illustration of the structural element 12, 14 showing the cross section along the line A-A from FIG. 2a. The structural element 12, 14 has a first wall 3 and a second wall 4, which are joined together and form the cavity 17.

A first exemplary embodiment of an insulating element 16 is shown in FIGS. 3a and 3b. The insulating element 16 has a carrier 11 and expandable material 13 arranged on the carrier 11. The carrier 11 comprises a closed surface 8 and three side walls 9 that are fastened to said closed surface 8 via ribs 7. The carrier 11 furthermore comprises two fastening elements 5. FIG. 3a shows the insulating element 16 from a first side, and FIG. 3b shows the same insulating element 16 from a second side.

FIGS. 4a and 4b in turn schematically illustrate the same insulating element 16 as in FIGS. 3a and 3b. Here, the insulating element 16 is illustrated in FIG. 4a in a state prior to expansion of the expandable material 13, and FIG. 4b illustrates the same insulating element 16 after expansion of the expandable material 13, such that the expanded material 13′ is visible.

In this exemplary embodiment, the entire region between the side walls 9 and the closed surface 8 has been filled with expanded material 13′. Here, the distance 20 denotes a spacing between in each case one side wall 9 and the closed surface 8. In tests, it has been found that greater distances 20 lead to better acoustic insulation performance than smaller distances 20 if the region between the side walls 9 and the closed surface 8 is substantially filled with expanded material 13′.

FIGS. 5a to 5c illustrate an alternative embodiment of an insulating element 16. Here, FIG. 5a illustrates only the carrier 11, and FIG. 5b illustrates only an expansion element 18. The carrier 11 and expansion element 18 together form the insulating element 16, as can be seen from FIG. 5c.

The carrier 11 again comprises a closed surface 8, fastening elements 5 and side walls 9 that are fastened to the closed surface 8 via ribs 7.

The expansion element 18 comprises the expandable material 13. In this exemplary embodiment, the expansion element 18 is furthermore equipped with its own carrier and with a coupling element 19 for coupling the expansion element 18 to the carrier 11.

A side wall 9 of the insulating element 16 is illustrated in more detail, schematically and by way of example, in FIGS. 6a to 6c. Here, FIG. 6a shows a detail from the insulating element as a whole, and FIG. 6b shows a view of the side wall 9 according to the section B-B from FIG. 6a. FIG. 6b shows the side wall 9 itself and the ribs 7.

Finally, FIG. 6c schematically shows an exemplary cross section along a plane in a region of an open end of the cavity 17. The structural element 12, 14 again comprises the first wall 3 and the second wall 4, which are joined together at joints. Here, the walls 3, 4 form the cavity 17. The side wall 9 is now arranged substantially in said plane of the cross section in the region of the open end of the cavity 17, such that the cross section of the cavity 17 is closed, over more than 50% of its extent, by the side wall 9. It has been found that such a closure of the open end of the cavity 17 by the side wall 9 is sufficient to targetedly stop an expansion of the expandable material 13.

Finally, FIGS. 7a to 8b schematically illustrate systems 1 and details from said systems 1. In FIGS. 7a and 7b, the expandable material 13 is in the non-expanded state, and in FIGS. 8a and 8b, the expandable material 13 is in the expanded state, such that the expanded material 13′ is illustrated.

It can be seen in FIGS. 7b and 8b that the closed surface 8 of the carrier 11 is effective in shielding the opening 6 in the wall 3 from the expanded material 13′. The opening 6 thus remains free for an intended assembly purpose.

FIG. 8b furthermore shows that a region of the cavity 17 between the closed surface 8 and the second wall 4 can be completely filled with expanded material 13. This leads to a better acoustic insulating action.

### LIST OF REFERENCE SIGNS

1 System
2 Portion
3 First wall
4 Second wall
5 Fastening element
6 Opening
7 Rib
8 Closed surface
9 Side wall
10 Vehicle body
11 Carrier
12 Structural element
13 Expandable material
13′ Expanded material
14 Structural element
16 Insulating element
17 Cavity
18 Expansion element
19 Coupling element
Distance
21 Cross section
22 Open end

1. A system of a structural element of a motor vehicle, having an insulating element arranged in the structural element, the system comprising:
a structural element which comprises at least two joined walls which, in one portion, form a cavity having at least two open ends, wherein a first wall has at least one opening in the portion;
an insulating element comprising a carrier and an expandable material arranged on the carrier, wherein the carrier comprises a closed surface and at least one side wall that is fastened to the closed surface via ribs, and wherein the expandable material has an expansion rate of at least 800%;
wherein the insulating element is arranged in the structural element such that the closed surface of the carrier overlaps and covers the opening of the first wall in a plan view of the opening, and such that the at least one side wall is arranged substantially in a plane of a cross section in a region of an open end of the cavity and thus closes the cross section of the cavity in the region of the open end over at least 50% of the cross section.

2. The system as claimed in claim 1, wherein, in a plan view of the opening, the closed surface covers an area amounting to at least 300% of an area of the opening.

3. The system as claimed in claim 1, wherein the closed surface is arched in the shape of a dome over the opening.

4. The system as claimed in claim 1, wherein the at least one side wall closes the cross section of the cavity in the region of the open end over at least 70% of the cross section.

5. The system as claimed in claim 1, wherein the carrier has two side walls which are spaced from one another by at least 100 mm.

6. The system as claimed in claim 1, wherein the carrier has two side walls which are arranged at an angle of between 30° and 150° with respect to one another.

7. The system as claimed in claim 1, wherein the carrier has at least two side walls, and wherein the closed surface of the carrier is arranged substantially between the side walls.

8. The system as claimed in claim 1, wherein a distance between in each case one side wall and the closed surface is at least 20 mm, such that, as a result of an expansion of the expandable material, a layer of the expanded material with a thickness of at least 20 mm can be formed on the side wall.

9. The system as claimed in claim 1, wherein the expandable material has an expansion rate of at least 2000%.

10. The system as claimed in claim 1, wherein, in a region of the opening, no expandable material is arranged on that side of the closed surface which faces toward the opening.

11. The system as claimed in claim 1, wherein more expandable material is arranged on a side of the carrier facing away from the opening than on a side of the carrier facing toward the opening.

12. The system as claimed in claim 1, wherein the expandable material is arranged and dimensioned such that a region between the closed surface and the second wall is completely filled with expanded material after an expansion process.

13. The system as claimed in claim 1, wherein each side wall is connected to the closed surface by means of two to six ribs.

14. The system as claimed in claim 1, wherein the portion of the structural element is of elongate shape and forms a cavity having two open ends, and/or wherein the carrier has two side walls that partially close in each case one open end of the cavity.

15. The system as claimed in claim 1, wherein the portion of the structural element is T-shaped and forms a cavity having three open ends, and/or wherein the carrier has three side walls that partially close in each case one open end of the cavity.
